(19) United States
(12) Patent Application Publication
(10) Pub. No.: US 2026/0288575 A1
(43) Pub. Date: Sep. 24, 2026

(54) Reference Marks Constructed from Set Reference Patterns in DNA Data Storage

(71) Applicant: Western Digital Technologies, Inc., San Jose, CA (US)

(72) Inventors: Iouri Oboukhov, Rochester, MN (US); Richard Galbraith, Rochester, MN (US); Niranjay Ravindran, Rochester, MN (US); Austin Striegel, Rochester, MN (US)

(21) Appl. No.: 19/082,645

(22) Filed: Mar. 18, 2025

(51) Int. Cl. G06F 11/10

(52) U.S. Cl. CPC G06F 11/1004

(57) ABSTRACT

Example systems and methods for embedding reference marks for a set of different reference patterns across a set of oligos for DNA data storage are described. A data unit may be encoded in oligos that include reference marks at predetermined intervals along the length of each oligo, where different reference patterns are selected for different oligos to reduce redundancy in DNA synthesis. During decoding, the reference marks may be analyzed through multiple correlation matrices to determine a most likely reference pattern from the set of reference patterns for that oligo. The most likely reference pattern can then be used for determining insertions and deletions in the oligo. In some configurations, the same reference marks may encode an oligo address for the oligo.

### TECHNICAL FIELD

The present disclosure relates to deoxyribonucleic acid (DNA) data storage. In particular, the present disclosure relates to error correction for data stored as a set of synthetic DNA oligos.

### BACKGROUND

DNA is a promising technology for information storage. It has potential for ultra-dense three-dimensional (3D) storage with high storage capacity and longevity. Currently, the technology of DNA synthesis provides tools for synthesis and manipulation of relatively short synthetic DNA chains (oligos). For example, some oligos may include 40 to 350 bases encoding twice that number of bits in configurations that use bit symbols mapped to the four DNA nucleotides or sequences thereof. Due to the relatively short payload capacity of oligos, Reed-Solomon error correction codes have been applied to individual oligos.

There is a need for technology that applies more efficient error correction codes to DNA data storage and retrieval.

### BRIEF DESCRIPTION OF THE DRAWINGS

The techniques introduced herein are illustrated by way of example, and not by way of limitation, in the figures of the accompanying drawings in which like reference numerals are used to refer to similar elements.

FIG. 1A is a block diagram of a prior art DNA data storage process.

FIG. 1B is a block diagram of a prior art DNA data storage decoding process for oligos encoded with binary data.

FIG. 2 is a block diagram of an example encoding system and example decoding system for DNA data storage using reference marks based on fixed sets of reference patterns.

FIGS. 3A and 3B are diagrams of oligo processing to determine the reference marks in oligo read data.

FIG. 4 is a block diagram of an oligo data processing system using fixed sets of reference patterns to restore reference mark timing and optionally determine oligo address.

FIG. 5A is a block diagram of oligo address processing and mapping to set reference patterns.

FIG. 5B is a block diagram of oligo address processing to add redundancy data to oligo address segments.

FIGS. 6A, 6B, and 6C are example methods for recovering reference mark timing and oligo index data stored in embedded reference marks in oligo read data, such as using the decoding systems of FIGS. 2 and 4.

FIG. 7 is an example method for encoding reference marks in oligos, such as using the encoding system of FIG. 2.

FIG. 8 is an example method for determining probabilities of reference mark shifts using a Viterbi algorithm, such as using the decoding systems of FIGS. 2 and 4.

### SUMMARY

Various aspects for using a fixed set of reference patterns in reference marks for encoding and decoding data stored in an oligo pool for DNA data storage are described. The reference patterns may also be selected to embed oligo address data in the reference marks.

One general aspect includes a system that includes at least one encoder circuit configured to, alone or in combination: determine an oligo from a set of oligos for encoding a data unit, where the oligo encodes a number of symbols corresponding to user data in the data unit; select a first reference pattern from a plurality of reference patterns configured to be used to encode the set of oligos; insert a plurality of reference marks at a predetermined interval along a length of the oligo, where at least a portion of the plurality of reference marks correspond to the first reference pattern, and the predetermined interval equals a fixed data length between sequential reference marks; and output write data for the oligo for synthesis of the oligo.

Implementations may include one or more of the following features. The predetermined interval of the plurality of reference marks may correspond to a single base pair between sequential reference marks. Instances of each reference pattern in the plurality of reference patterns may be distributed among reference marks inserted into different oligos from the set of oligos. A number of different reference patterns in the plurality of reference patterns may be at least 16. Each reference pattern in the plurality of reference patterns may encode at least 8 bits of reference pattern data. The at least one encoder circuit may be further configured to, alone or in combination: segment the number of symbols into a plurality of oligo data segments; and select a number of different reference patterns from the plurality of reference patterns equal to a number of the plurality of oligo data segments. The selected different reference patterns may include the first reference pattern, and the plurality of reference marks may correspond to the selected different reference patterns inserted into corresponding oligo data segments in the plurality of oligo data segments. The number of different reference patterns and the number of the plurality of oligo data segments may be at least 5. The at least one encoder circuit may be further configured to, alone or in combination: determine an oligo address for the oligo; segment the oligo address into a plurality of oligo address segments; and select different reference patterns from the plurality of reference patterns corresponding to the plurality of oligo address segments. The plurality of reference marks may correspond to the selected different reference patterns inserted into the oligo; the oligo address may be configured to locate the number of symbols in the data unit relative to other oligos in the set of oligos; and the selected different reference patterns may include the first reference pattern. The oligo address segments may have a first length; the selected different reference patterns may have a second length; the at least one encoder circuit may be further configured to, alone or in combination, modify, prior to selecting the different reference patterns, each oligo address segment of the plurality of oligo address segments with redundancy data for that oligo address segment; and the redundancy data for each oligo address segment has a length equal to a difference between the first length and the second length. The system may further include at least one decoder circuit configured to alone or in combination: receive read data determined from sequencing the oligo; determine, from the read data, a convolutional matrix for the oligo, where each column of the convolutional matrix corresponds to a base pair offset of the read data for the oligo; select, from a plurality of reference matrices corresponding to the set of reference patterns, a reference matrix for the plurality of reference marks; determine a correlation matrix based on a comparison of the convolutional matrix to the selected reference matrix; determine a most likely path through the correlation matrix for the selected reference matrix; determine a score for the most likely path using the selected reference matrix; execute selecting the reference matrix, determining the correlation matrix, determining the most likely path, and determining the score for the plurality of reference matrices to generate scores for each reference matrix of the plurality of reference matrices; determine, by comparing the scores, a best fit reference matrix for the read data; and decode the oligo based on insertions and deletions indicated by the most likely path for the best fit reference matrix.

Another general aspect includes a method that includes receiving read data determined from sequencing an oligo from a set of oligos for encoding a data unit, where: the oligo encodes a number of symbols corresponding to user data in the data unit; the oligo may include a plurality of reference marks at a predetermined interval along a length of the oligo; at least a portion of the plurality of reference marks corresponds to a first reference pattern selected from a plurality of reference patterns configured to be used to encode the set of oligos; and the predetermined interval equals a fixed data length between sequential reference marks. The method also includes: determining, from the read data, a convolutional matrix for the oligo, where each column of the convolutional matrix corresponds to a base pair offset of the read data for the oligo; selecting, from a plurality of reference matrices corresponding to the set of reference patterns, a reference matrix for the plurality of reference marks; determining a correlation matrix based on a comparison of the convolutional matrix to the selected reference matrix; determining a most likely path through the correlation matrix for the selected reference matrix; and decoding the oligo based on insertions and deletions indicated by the most likely path.

Implementations may include one or more of the following features. The predetermined interval of the plurality of reference marks may correspond to a single base pair between sequential reference marks. Instances of each reference pattern in the plurality of reference patterns may be distributed among reference marks inserted into different oligos from the set of oligos. The method may include: determining a score for the most likely path using the selected reference matrix; executing selecting the reference matrix, determining the correlation matrix, determining the most likely path, and determining the score for the plurality of reference matrices to generate scores for each reference matrix of the plurality of reference matrices; and determining, by comparing the scores, a best fit reference matrix for the read data, where decoding the oligo is based on the most likely path for the best fit reference matrix. The method may include: determining, based on the best fit reference matrix, an encoded reference pattern; segmenting the encoded reference pattern into a plurality of reference pattern segments corresponding to a plurality of oligo address segments; and determining, based on the plurality of oligo address segments, an oligo address for the oligo, where the oligo address is configured to locate the number of symbols in the data unit relative to other oligos in the set of oligos. The method may include: determining, for each reference pattern segment of the plurality of reference pattern segments, redundancy data for that reference pattern segment; executing, using the redundancy data for each reference pattern segment, a redundancy check for the corresponding oligo address segment in that reference pattern segment to verify integrity of the oligo address; and assembling the plurality of oligo address segments into the oligo address. The method may include, during an encoding operation for the oligo: determining the oligo from the set of oligos for encoding the data unit; selecting the first reference pattern from the plurality of reference patterns; inserting the plurality of reference marks at the predetermined interval along the length of the oligo; and outputting write data for the oligo for synthesis of the oligo. The method may include, during the encoding operation for the oligo: segmenting the number of symbols into a plurality of oligo data segments; and selecting a number of different reference patterns from the plurality of reference patterns equal to a number of the plurality of oligo data segments, where the selected different reference patterns include the first reference pattern and the plurality of reference marks corresponds to the selected different reference patterns inserted into corresponding oligo data segments in the plurality of oligo data segments. The method may include, during the encoding operation for the oligo: determining an oligo address for the oligo; segmenting the oligo address into a plurality of oligo address segments; and selecting different reference patterns from the plurality of reference patterns corresponding to the plurality of oligo address segments, wherein the plurality of reference marks corresponds to the selected different reference patterns inserted into the oligo, the oligo address is configured to locate the number of symbols in the data unit relative to other oligos in the set of oligos, and the selected different reference patterns include the first reference pattern.

Still another general aspect includes a system that includes: at least one processor; at least one memory; means for receiving read data determined from sequencing an oligo from a set of oligos for encoding a data unit; means for determining, from the read data, a convolutional matrix for the oligo, where each column of the convolutional matrix corresponds to a base pair offset of the read data for the oligo; means for selecting, from a plurality of reference matrices corresponding to the set of reference patterns, a reference matrix for the plurality of reference marks; means for determining a correlation matrix based on a comparison of the convolutional matrix to the selected reference matrix; means for determining a most likely path through the correlation matrix for the selected reference matrix; and means for decoding the oligo based on insertions and deletions indicated by the most likely path. The oligo may encode a number of symbols corresponding to user data in the data unit; the oligo may include a plurality of reference marks at a predetermined interval along a length of the oligo; at least a portion of the plurality of reference marks may correspond to a first reference pattern selected from a plurality of reference patterns configured to be used to encode the set of oligos; and the predetermined interval may equal a fixed data length between sequential reference marks.

The present disclosure describes various aspects of innovative technology capable of applying embedded reference marks that correspond to fixed sets of reference patterns for a DNA oligo pool and traversing resulting correlation matrices using Viterbi algorithms to the encoding and decoding of user data stored in the DNA oligo pool. The configuration of reference marks and insertion/deletion error processing provided by the technology may be applicable to a variety of computer systems used to store or retrieve data stored as a set of oligos in a DNA storage medium. The configuration may be applied to a variety of DNA synthesis and sequencing technologies to generate write data for storage as base pairs and process read data read from those base pairs. The novel technology described herein includes a number of innovative technical features and advantages over prior solutions, including, but not limited to, improved data recovery based on elimination of insertion and deletion errors prior to applying other data recovery techniques (such as error correction codes and/or data correlation) to the insertion/deletion corrected user data.

### DETAILED DESCRIPTION

Prior encoding and decoding techniques for oligos have included inserting reference marks into the data to be encoded from the data unit to improve the ability to detect and correct errors, particularly insertion and deletion errors. For example, inserting reference marks at regular intervals along the length of the oligo may effectively provide a “timing” signal for the oligo, where insertions or deletions between a set of reference marks are detected as a position shift in the reference marks. In some configurations, reference marks and encoded data may occur in alternating base pairs along the length of the oligo, and a fixed pattern in sequential reference marks may allow a decoder to identify the reference pattern and, thereby, the positions of individual reference marks.

However, the use of a fixed reference pattern across a pool of oligos may increase the transcription errors during DNA synthesis. Because repeated patterns are more likely to induce insertion, deletion, and mutation errors, encoding each oligo in an oligo pool with the same reference pattern may increase the number of errors and undermine the error correction capabilities of the reference marks. However, randomized reference marks would be indistinguishable from the user data. Therefore, using a fixed set of reference patterns that balance the need for variation within the oligo pool with the decoding overhead to determine which reference pattern or patterns are present in each oligo is desirable. In some configurations, at least 16 different reference patterns may provide the desired variability, though 32, 64, 128, or more different reference patterns may be desirable for some conditions.

Oligos in a DNA oligo pool for data storage may include addressing information that determines the order in which the data symbols encoded in that oligo should be ordered and reassembled with the data from other oligos into the larger data unit they collectively encode. Reference patterns that encode the oligo index or oligo address for each oligo have also been proposed. For example, by encoding the oligo address in the reference pattern of the reference marks, no additional overhead needs to be dedicated to oligo, reserving more base pairs for user data and the redundancy data to protect and recover that user data. In some configurations, an oligo pool may use 32-bit oligo index values for representing the oligo address in each oligo. Those 32 bits may use a detectable encoding scheme that allows them to be used as reference patterns and would generally be repeatedly encoded throughout the reference marks (possibly based on translation or mirroring schemes to reduce redundancy). However, this reference mark index encoding scheme, when implemented across an oligo pool, may still increase the number of transcription errors during synthesis. Therefore, a fixed set of reference patterns that provide segments of a complete reference pattern and may be assembled and combined to uniquely represent the oligo address in the reference marks is desirable. For example, a set of 256 reference pattern segments may be used to encode 8 bits of information, and a combination of these reference pattern segments could encode a 32-bit oligo index value. The distribution of these reference pattern segments among the oligos of the oligo pool, even though their patterns map to a 32-bit index, may provide sufficient variation to reduce transcription errors.

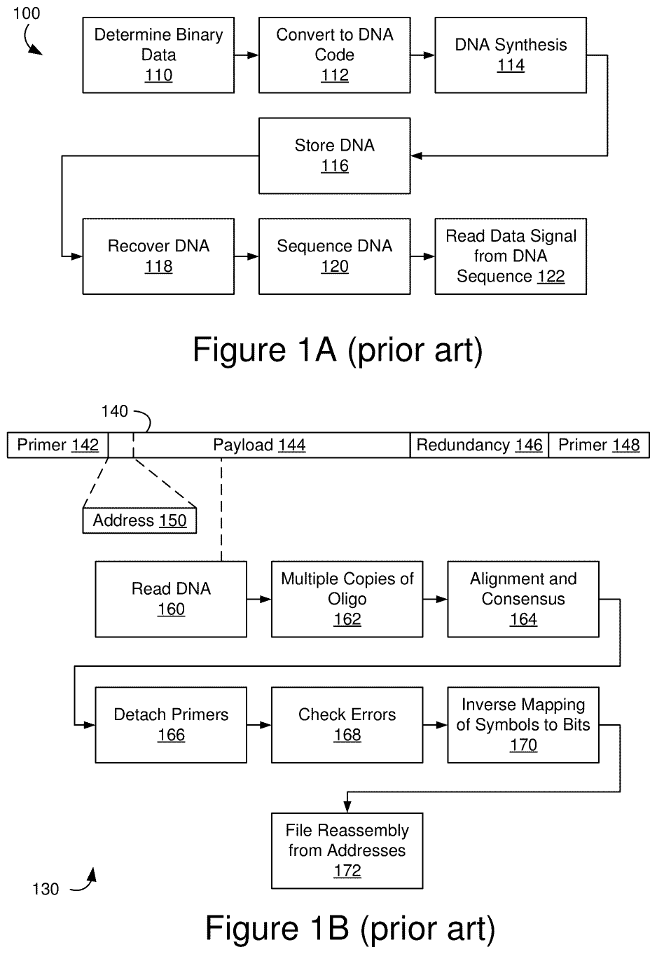

Novel data storage technology is being developed to use synthesized DNA encoded with binary data for long-term data storage. While current approaches may be limited by the time it takes to synthesize and sequence DNA, the speed of those systems is improving, and the density and durability of DNA as a data storage medium is compelling. In an example configuration in FIG. 1A, a method 100 may be used to store and recover binary data from synthetic DNA.

At block 110, binary data for storage to the DNA medium may be determined. For example, any conventional computer data source may be targeted for storage in a DNA medium, such as data files, databases, data objects, software code, etc. Due to the high storage density and durability of DNA media, the data targeted for storage may include very large data stores having archival value, such as collections of images, videos, scientific data, software, enterprise data, and other archival data. These conventional data sources may include data units for storage, such as data blocks of a particular size, such as 512 kilobyte (KB), 1 megabyte (MB), 2 MB, or 4 MB blocks.

At block 112, the binary data may be converted to DNA code. For example, a conventional computer data object or data file may be encoded according to a DNA symbol index, such as: A or T=1 and C or G=0; A=00, T=01, C=10, and G=11; or a more complex DNA symbol index mapping sequences of DNA bases to predetermined binary data patterns. In some configurations, prior to conversion to DNA code, the source data may be encoded according to an oligo-length format that includes addressing and redundancy data for use in recovering and reconstructing the source data during the retrieval process.

At block 114, DNA may be synthesized to embody the DNA code determined at block 112. For example, the DNA code may be used as a template for generating a plurality of synthetic DNA oligos embodying that DNA code using various DNA synthesis techniques. In some configurations, a large data unit is broken into segments matching a payload capacity of the oligo length being used, and each segment is synthesized in a corresponding DNA oligo. In some configurations, solid-phase DNA synthesis may be used to create the desired oligos. For example, each desired oligo may be built on a solid support matrix one base at a time to match the desired DNA sequence, such as using phosphoramidite synthesis chemistry in a four-step chain elongation cycle. In some configurations, column-based or microarray-based oligo synthesizers may be used.

At block 116, the DNA medium may be stored. For example, the resulting set of DNA oligos for the data unit may be placed in a fluid or solid carrier medium. The resulting DNA medium of the set of oligos and their carrier may then be stored for any length of time with a high-level of stability (e.g., DNA that is thousands of years old had been successfully sequenced). In some configurations, the DNA medium may include wells of related DNA oligos suspended in carrier fluid or a set of DNA oligos in a solid matrix that can themselves be stored or attached to another object. A set of DNA oligos stored in a binding medium may be referred to as a DNA storage medium for an oligo pool. The DNA oligos in the pool may relate to one or more binary data units comprised of user data (the data to be stored prior to encoding and addition of syntactic data, such as headers, addresses, reference marks, etc.).

At block 118, the DNA oligos may be recovered from the stored medium. For example, the oligos may be separated from the carrier fluid or solid matrix for processing. The resulting set of DNA oligos may be transferred to a new solution for the sequencing process or may be stored in a solution capable of receiving the other polymerase chain reaction (PCR) reagents.

At block 120, the DNA oligos may be sequenced and read into a DNA data signal corresponding to the sequence of bases in the oligo. For example, the set of oligos may be processed through PCR to amplify the number of copies of the oligos from the stored set of oligos. In some configurations, PCR amplification may result in a variable number of copies of each oligo.

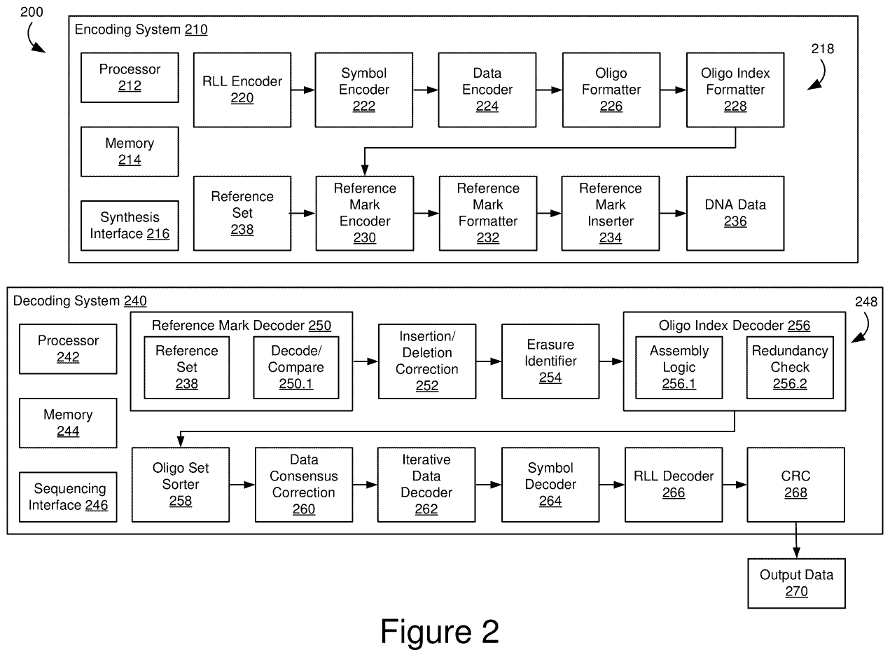

At block 122, a data signal may be read from the sequenced DNA oligos. For example, the sequenced oligos may be passed through a nanopore reader to generate an electrical signal corresponding to the sequence of bases. In some configurations, each oligo may be passed through a nanopore, and a voltage across the nanopore may generate a differential signal with magnitudes corresponding to the different resistances of the bases. The analog DNA data signal may then be converted back to digital data based on one or more decoding steps, as further described with regard to a method 130 in FIG. 1B. Improved systems and methods for processing read data from the sequenced oligos to recover the data encoded in the original oligo, including both address/index data and user data, are further described with regard to FIGS. 2-7.

In FIG. 1B, method 130 may be used to convert an analog read signal corresponding to a sequence of DNA bases back to the digital data unit that was the original target of the DNA storage process. In the example shown, the original digital data unit, such as a data file, was broken into data subunits corresponding to a payload size of the oligos, and the set of oligos corresponding to the subunits of the data unit may be reassembled into the original data unit. An example oligo format 140, including primers 142 and 148 that may be added to support the PCR amplification and sequencing, may include a payload 144 comprising a subunit of the data unit, a redundancy portion 146 for error correction code (ECC) data for that subunit, and an address portion 150 for determining the sequence of the payloads for reassembling the data block. In some configurations, Reed-Solomon error correction codes may be used to determine the redundancy portion 146 for payload 144.

At block 160, DNA base data signals may be read from the sequenced DNA. For example, the analog signal from the nanopore reader may be conditioned (equalized, filtered, etc.) and converted to a digital data signal for each oligo.

At block 162, multiple copies of the oligos may be determined. Through the amplification process, multiple copies of each oligo may be produced, and the decoding system may determine groups of the same oligo to process together.

At block 164, each group of the same oligo may be aligned, and consensus across the multiple copies may be determined. For example, a group of four copies may be aligned based on their primers, and each base position along the set of base values may have a consensus algorithm applied to determine a most likely version of the oligo for further processing, such as, where 3 out of 4 agree, that value is used.

At block 166, the primers may be detached. For example, primers 142 and 148 may be removed from the set of data corresponding to payload data 144, redundancy data 146, and address 150.

At block 168, error checking may be performed on the resulting data set. For example, ECC processing of payload 144 based on redundancy data 146 may allow errors in the resulting consensus data set for the oligo to be corrected. The number of correctable errors may depend on the ECC code used. ECC codes may have difficulty correcting errors created by insertions or deletions (resulting in shifts of all following base values). The size of the oligo payload 144 and portion allocated to redundancy data 146 may determine and limit the correctable errors and efficiency of the data format.

At block 170, the bases or base symbols may be inversely mapped back to the original bit data. For example, the symbol encoding scheme used to generate the DNA code may be reversed to determine corresponding sequences of bit data.

At block 172, a file or similar data unit may be reassembled from the bit data corresponding to the set of oligos. For example, address 150 from each oligo payload may be used to order the decoded bit data and reassemble the original file or other data unit.

FIG. 2 shows an improved DNA storage system 200 and, more specifically, an improved encoding system 210 and decoding system 240 for using multistage error correction using reference marks to correct for insertion/deletion errors before applying other error correction techniques to address mutation and/or erasure errors. In some configurations, encoding system 210 may be part of a first computer or storage system or device used for determining target binary data, such as a conventional binary data unit, and converting it to a DNA base sequence for synthesis into DNA for storage, and decoding system 240 may be part of a second computer or storage system or device used for receiving the data signal corresponding to the base sequence read from the DNA.

Encoding system 210 may include a processor 212, a memory 214, and a synthesis system interface 216. For example, encoding system 210 may be part of a computer or storage system or device configured to receive or access conventional computer data, such as data stored as binary files, blocks, data objects, databases, etc., and map that data to a sequence of DNA bases for synthesis into DNA storage units, such as a set of DNA oligos. Processor 212 may include any type of conventional processor or microprocessor that interprets and executes instructions. In some configurations, processor 212 may include a plurality of processors or processor cores configured to operate alone or in combination to execute one or more functions or sets of instructions described with regard to the other components of encoding system 210. Memory 214 may include a random-access memory (RAM) or another type of dynamic storage device that stores information and instructions for execution by processor 212 and/or a read only memory (ROM) or another type of static storage device that stores static information and instructions for use by processor 212. In some configurations, one or more components of encoding system 210 may be embodied in specialized logic and memory circuits configured for the functions described for encoding system 210 and may incorporate or operate in conjunction with processor 212 and memory 214. For example, one or more encoders, formatters, and/or insertion functions may be embodied in a specialized encoder circuit, such as a system on a chip (SOC), field programmable gate array (FPGA), application specific integrated circuit (ASIC), or similar circuit configuration. Encoding system 210 may also include any number of input/output devices and/or interfaces. Input devices may include one or more conventional mechanisms that permit an operator to input information to encoding system 210, such as a keyboard, a mouse, a pen, voice recognition and/or biometric mechanisms, etc. Output devices may include one or more conventional mechanisms that output information to the operator, such as a display, a printer, a speaker, etc. Interfaces may include any transceiver-like mechanism that enables encoding system 210 to communicate with other devices and/or systems. For example, synthesis interface 216 may include a connection to an interface bus (e.g., peripheral component interconnect express (PCIe) bus) or network for communicating the DNA base sequences for storing the data to a DNA synthesis system. In some configurations, synthesis interface 216 may include a network connection using internet or similar communication protocols to send a conventional data file listing the DNA base sequences for synthesis, such as the desired sequence of bases for each oligo to be synthesized, to the DNA synthesis system. In some configurations, the DNA base sequence listing may be stored to conventional removable media, such as a universal serial bus (USB) drive or flash memory card, and transferred from encoding system 210 to the DNA synthesis system using the removable media.

In some configurations, a series of processing components 218 may be used to process the target binary data, such as a target data file, data block, or other data unit, into the DNA base sequence listing for output to the synthesis system. For example, processing components 218 may be embodied in encoder software and/or hardware encoder circuits. In some configurations, processing components 218 may be embodied in one or more software modules stored in memory 214 for execution by processor 212. Note that the series of processing components 218 are examples, and different configurations and ordering of components may be possible without materially changing the operation of processing components 218. For example, in an alternate configuration, additional data processing, such as a data randomizer to whiten the input data sequence, may be used to preprocess the data before encoding. In another configuration, user data from a target data unit may be divided across a set of oligos according to oligo payload size or other data formatting prior to applying any encoding, or synchronization (or sync) marks may be added after ECC encoding. Other variations are possible.

In some configurations, processing the target data may begin with a run length limited (RLL) encoder 220. RLL encoder 220 may modulate the length of stretches in the input data. RLL encoder 220 may employ a line coding technique that processes arbitrary data with bandwidth limits. Specifically, RLL encoder 220 may bound the length of stretches of repeated bits or specific repeating bit patterns so that the stretches are not too long or too short. By modulating the data, RLL encoder 220 can reduce problematic data sequences that could create additional errors in subsequent encoding and/or DNA synthesis or sequencing. In some configurations, RLL encoder 220 or a similar data modulation component may be configured to modulate the input data to ensure that data patterns used for syntax references do not appear elsewhere in the user data encoded in the oligo.

In some configurations, symbol encoder 222 may include logic for converting binary data into symbols based on the four DNA bases (adenine (A), cytosine (C), guanine (G), and thymine (T)). In some configurations, symbol encoder 222 may encode each bit as a single base pair, such as 1 mapping to A or T and 0 mapping to G or C. In some configurations, symbol encoder 222 may encode two-bit symbols into single bases, such as 11 mapping to A, 00 mapping to T, 01 mapping to G, and 10 mapping to C. More complex symbol mapping can be achieved based on multi-base symbols mapping to correspondingly longer sequences of bit data. For example, a two-base symbol may correspond to 16 states for mapping four-bit symbols, or a four-base symbol may map the 256 states of byte symbols. Multi-base pair symbols could be preferable from an oligo synthesis point of view. For example, synthesis could be done not on base pairs but on larger blocks, like ‘bytes’ correlating to a symbol size, which are prepared and cleaned up earlier (e.g., pre-synthesized) in the synthesis process. This may reduce the amount of synthesis errors. From an encoder/decoder point of view, these physically larger blocks could be treated as symbols or a set of smaller symbols.

In some configurations, data encoder 224 may include logic for encoding the user data unit using one or more error correction schemes and may encode user data units across multiple oligos. For example, encoding system 210 may use low-density parity check (LDPC) codes constructed for the oligo size and/or larger codewords than can be written to a single oligo. In some configurations, data across multiple oligos may be aggregated to form the desired codewords. Similarly, parity or similar redundancy data may not need to be written to each oligo and may instead be written to only a portion of the oligos or written to separate parity oligos that are added to the oligo set for the target data unit. In some configurations, ECC encoding may then be nested for increasingly aggregated sets of oligos, where each level of the nested ECC corresponds to increasingly larger codewords comprised of more oligos. Encoding system 210 may include one or more oligo aggregators and corresponding iterative encoders. For example, single level ECC encoding may use first level oligo aggregator and first level iterative encoder for codewords of 200-400 oligos. A two-level encoding scheme would use first and second level oligo aggregators for and corresponding first and second level iterative encoders, such as for 200 oligo codewords at the first level and 4000 oligo codewords at the second level.

Data encoder 224 may append one or more parity bits or similar redundancy data to the sets of codeword data for later detection whether certain errors occur during data reading process. For instance, an additional binary bit (a parity bit) may be added to a string of binary bits that are moved together to ensure that the total number of “1”s in the string is even or odd. The parity bits may thus exist in two different types: an even parity in which a parity bit value is set to make the total number of “1”s in the string of bits (including the parity bit) to be an even number, and an odd parity in which a parity bit is set to make the total number of “1”s in the string of bits (including the parity bit) to be an odd number. In some examples, data encoder 224 may implement a linear error correcting code, such as LDPC codes or other turbo codes, to generate codewords that may be written to and more reliably recovered from the DNA medium. In some configurations, resulting parity or similar redundancy data may be stored in parity oligos designated to receive the redundancy data for the set of oligos that make up the codeword data. This additional parity data may be encoded using RLL encoder 220, symbol encoder 222, oligo formatter 226, and/or reference mark logic.

In some configurations, oligo formatter 226 may include logic for allocating portions of the target data unit to a set of oligos. For example, oligo formatter 226 may be configured for a predetermined payload size for each oligo and select a series of symbols corresponding to the payload size for each oligo in the set. In some configurations, the payload size may be determined based on an oligo size used by the synthesis system and any portions of the total length of the oligo that are allocated to redundancy data, address data, reference mark data, or other data formatting constraints. For example, a 150 base pair oligo using two-base symbols may include an eight-base addressing scheme and six four-base sync marks, resulting in 118 base pairs of the target data allocated to each oligo. In some configurations, oligo formatter 226 may insert a unique oligo address or oligo index (including the oligo address) for each oligo in the set, such as at the beginning or end of the data payload. The oligo address may allow the encoding and decoding systems to identify the data unit and relative position of the symbols in a particular oligo relative to the other oligos that contribute data to that data unit. For example, decoding system 240 may use position information corresponding to the oligo addresses to reassemble the data unit from a set of oligos in an oligo pool containing one or more data units. In some configurations, rather than including the oligo index in a data sequence separate from the user data payload, such as a header or footer of the oligo data, the oligo index may be embedded or encoded in the reference marks distributed through the data payload. This may allow the reference marks to double as oligo index space, reducing overall data overhead, and allow for redundant copies of the oligo index to be more reliably encoded in the oligo.

In some configurations, oligo index formatter 228 may include logic to assemble the oligo index data to be included in the oligo. In prior oligo data formats, oligo index formatter 228 may operate as part of oligo formatter 226 to collect and format the oligo index data for the sequence of base pairs that would store the index, such as a specific set of base pairs within the oligo header. In configurations that embed the oligo index in a distributed fashion, such as embedded within the sequence of reference marks, oligo index formatter 228 may operate separately from oligo formatter 226 to conform with the reference mark format determined by reference mark encoder 230, reference mark formatter 232, and reference mark inserter 234. Oligo index formatter 228 may determine a sequence or set of base pairs that correspond to the oligo index data, such as the oligo address, one or more other syntactical parameters, and/or encoding specific to the oligo index (e.g., oligo index cyclic redundancy check (CRC) or parity bits). In some configurations, the oligo index data may include only the oligo address, with or without redundancy data. The set of data for the oligo index may include an oligo address value of a predetermined bit length to provide unique addresses to the set of oligos in a DNA oligo pool. In some configurations, the oligo index value may be mapped or translated into a set of reference patterns for encoding in the reference marks of the oligo.

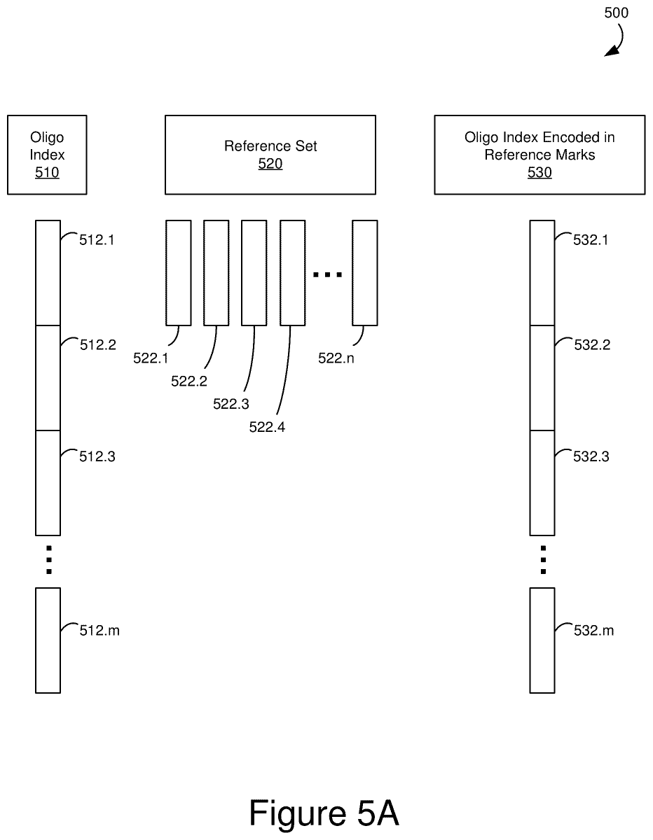

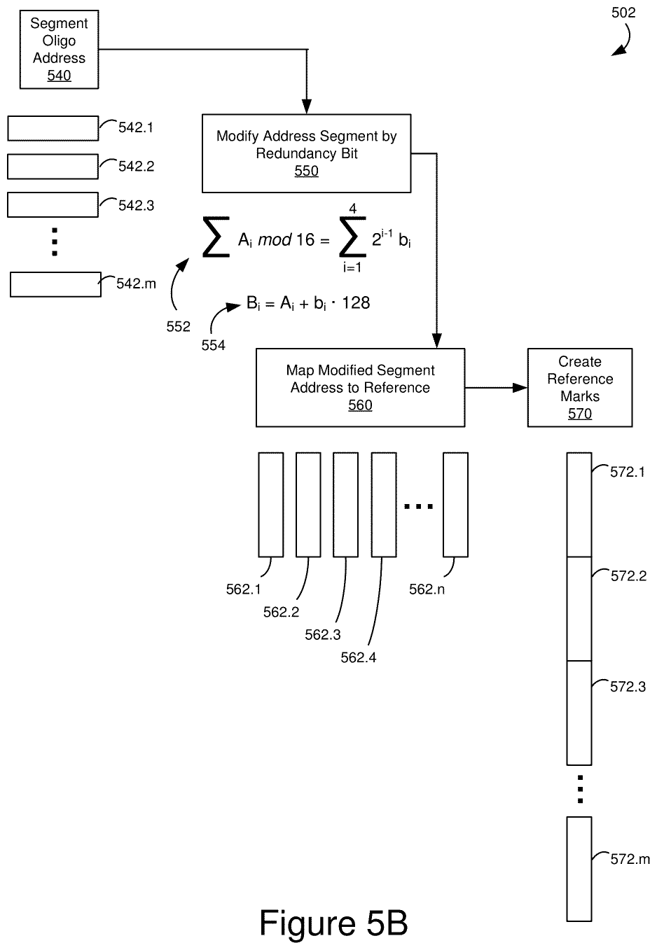

As shown in FIG. 5A, an oligo index 510, such as an oligo address value, may be divided into a plurality of segments 512.1-512.m, such as oligo address segments. For example, a 32-bit oligo address may be segmented into four 8-bit oligo address segments that combine to include the entire oligo address. In some configurations, the oligo address segments may be mapped to values in the set of reference patterns. For example, reference set 520 may include a library of 256 reference patterns 522.1-522.n that each correlate to a unique 8-bit value. Oligo address segments 512.1-512.m may each be mapped to a corresponding reference pattern that encodes that segment value. When the mapped reference patterns 532.1-532.m are written sequentially in the reference marks of an oligo, they effectively encode the oligo index 530 as the reference pattern segments in the reference marks. Note that each reference pattern segment may be substantially longer than 8 bits and represent a reference pattern encoded for detectability in the reference marks that is then mapped to one of the 8-bit values. For example, each reference pattern segment may be comprised of more than 20 base pairs. The number of reference patterns in the library of reference patterns and the size of those reference pattern segments may depend on the size of the oligo index to be encoded, the size of the oligo (and number of base pairs allocated to reference marks), and the encoding used to assure detectability of the reference pattern. For example, for oligos of 400-600 base pairs, reference pattern segments of 50-80 base pairs are feasible and may be reliably mapped to 8-bit values.

In some configurations, additional redundancy data may be encoded in the reference marks with the oligo address to assure oligo address recovery and integrity. As shown in FIG. 5B, at block 540, the oligo address may be segmented similarly to FIG. 5A. For example, a 28-bit oligo address may be segmented into oligo address segments 542.1-542.m, such as four 7-bit address segments. At block 550, each address segment may be modified by a redundancy bit. For example, each oligo address segment may be denoted A1-A4. A pair of parity equations 552 and 554 may be used to determine the redundancy bit value for each oligo address segment:

$$\sum {A}_{i} mod 16 = {\sum }_{i = 1}^{4} {2}^{i - 1} {b}_{i}$$

$${B}_{i} = {A}_{i} + {b}_{i} \cdot 128$$

Each modified oligo address segment may be an 8-bit value that includes the original 7-bit oligo address and one bit of redundancy data. Each oligo address segment has a predetermined length, and the redundancy scheme used may add one or more bit values to the predetermined length such that the modified oligo address segment has a longer length that is within the data capacity of the set of reference patterns that the segments are mapped to. At block 560, each modified oligo address segment is mapped to a corresponding reference pattern segment from the set of reference patterns 562.1-562.n. For example, the 8-bit modified oligo address segments may each uniquely correspond to one of the 256 reference patterns. At block 570, the sequence of reference pattern segments 572.1-572.m is stored by creating the corresponding reference pattern in the reference marks of the oligo.

In some configurations, reference mark encoder 230 may include logic for determining a pattern of values to be used for reference marks. For example, a series of base pairs placed at rigid, predetermined intervals or frequency may conform to a known sequence for detecting the presence of the reference marks interspersed with user data over the length of the oligo. In some configurations, each reference mark may be a single base pair and, thus, would not be inherently distinguishable from user data encoded using that base pair. However, when aggregated across a series or set of reference marks, the reference marks may be identified as syntactic reference pattern separate from the user data they provide a reference for. By using a rigid interval or frequency of a fixed number of user data base pairs between reference mark base pairs, a pattern similar to the timing structure used in the reading and writing of moving media, such as rotating magnetic/optical disks or linear magnetic tapes, may be established. In some configurations, similar encoding and logics from timing marks in moving media may be used for reference marks. For example, a convolutional code, including hash encoded decoded by greedy exhaustive search (HEDGES) ECC, that is configured for detection and recovery across a series of reference marks, may be selected. In some configurations, reference mark encoder 230 may include a cyclic redundancy check (CRC) code that may be used to verify the sequence in the reference marks during the decoding process. In some configurations, reference mark encoder 230 may select or assemble reference patterns from a reference set 238 that includes a fixed set of known or predetermined reference patterns or reference pattern segments that provide detectable patterns for reestablishing the data frequency during decoding without unduly increasing the error rates in DNA synthesis.

In some configurations, reference mark encoder 230 may operate on the oligo index data set received from oligo index formatter 228. For example, the oligo index data may be modulated and encoded using a convolutional code to be reliably distinguished from the user data as reference marks during decoding. That is, the oligo index data may form the basis of the reference mark pattern, and reference mark encoder 230 may be configured to receive and encode the oligo index data set for generation of the reference marks. In some configurations, the oligo index data may be mapped, with or without redundancy data, to reference pattern segments selected from reference set 238. Reference mark encoder 230 may provide the oligo address encoded as a series of reference pattern segments to reference mark formatter 232 for determining the configuration of the multiple reference pattern segments to be stored across the reference marks.

In some configurations, reference mark formatter 232 may include logic for formatting reference marks for insertion at predetermined intervals among the data symbols. For example, reference marks may be inserted every X base pairs to divide the data in the oligo into a predetermined number of shorter data segments with a timing frequency of 1/X and a resulting code rate of 1/(X+(base pairs in each reference mark)). In some configurations, each reference mark may comprise a single base pair as described for reference mark encoder 230 for a code rate of 1/(X+1). In some configurations, a code rate of 0.5 (1/(1+1), alternating a base pair of user data with a base pair reference mark) may be selected to provide a desired likelihood of reference recovery and a high likelihood of identifying and correcting insertion and deletion errors to return the user data to a desired timing/data pattern with only mutation and/or erasure errors to be addressed through user data ECC. In an example configuration, an oligo may have a payload space of 140 base pairs, and formatting the reference marks at a 0.5 code rate would result in 70 base pairs of user data alternating with 70 base pairs of reference marks. The predetermined sequence and frequency of the reference marks may be used during the decoding process to determine and evaluate user data segments within an oligo to better detect and localize insertions and deletions that are difficult for error correction codes to detect or correct. For example, decoding system 240 may detect reference marks and correct symbol alignment prior to attempting iterative decoding with ECC. Use of reference marks is further described below with regard to decoding system 240.

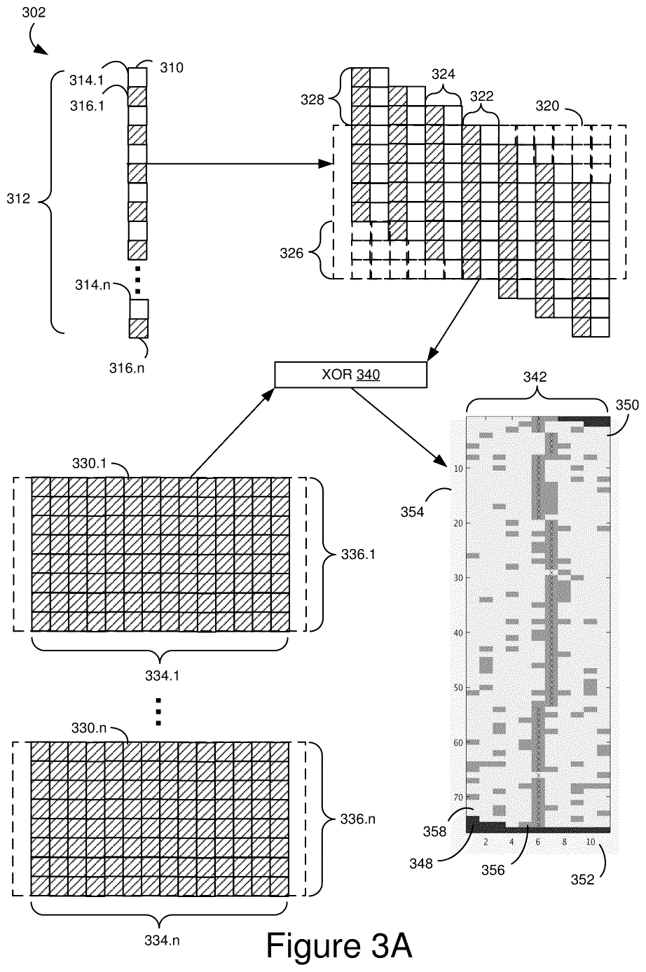

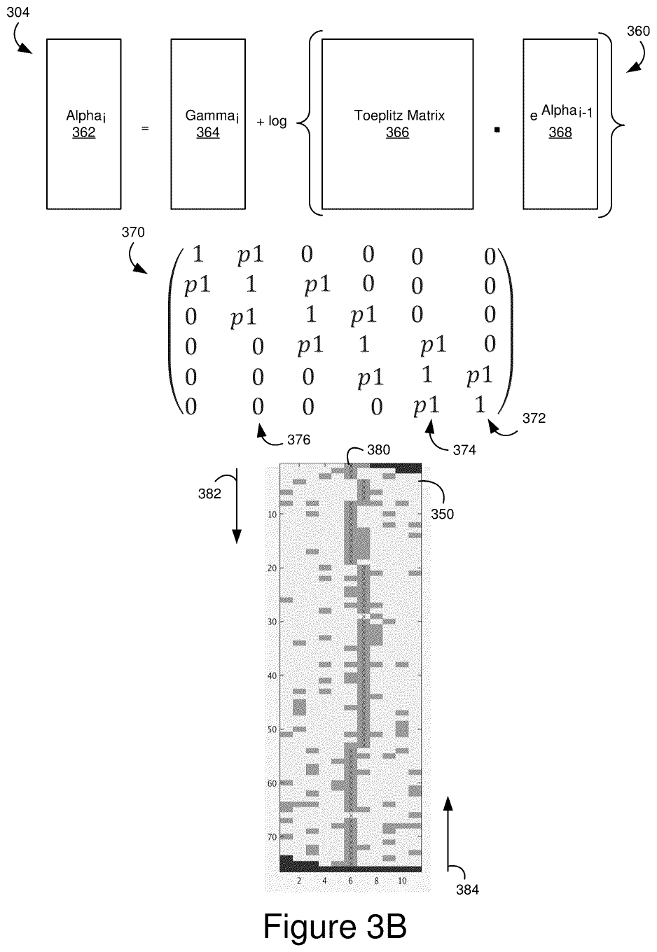

Reference mark formatter 232 may be configured to determine the number of reference pattern segments and configuration of those segments in the encoded reference pattern. For example, where the reference pattern is based on assembling a plurality of reference pattern segments, reference mark formatter 232 may determine the number of copies and the positions and/or translations of those segments across the reference marks. As shown in FIG. 3A, an example set of oligo data 310 may include user data base pairs 314.1-314.n alternating with reference mark base pairs 316.1-316.n. In the example shown, the oligo index comprises a base pair sequence 312 with a predetermined length for encoding user data alternating with reference marks. The sequence of reference marks 316.1-316.n may include a single reference pattern or a sequence of reference pattern segments assembled into a larger reference pattern. In some configurations, one or more reference pattern segments may be used to encode the oligo index or oligo address.

In some configurations, reference mark inserter 234 may include logic to insert the sequence of reference marks into the user data for determining the DNA sequence to be synthesized. For example, reference mark inserter 234 may operate according to the frequency configured in reference mark formatter 232 to insert the sequence of base pairs determined by reference mark encoder 230 and ordered copies from reference mark formatter 232 between corresponding portions of the user data. In the example using a code rate of 0.5, reference mark inserter 234 may alternate selecting a next base pair from the encoded user data with a next base pair from the reference marks to interleave single base pairs of user data with single base pair reference marks. In other configurations, a single base pair reference mark may be inserted after a plurality of user data base pairs, such as a larger (multi-base pair) symbol or segment size.

The resulting DNA base pair sequence corresponding to the encoded target data unit may be output from processing components 218 as DNA data 236. For example, the base pair sequences for each oligo in the set of oligos corresponding to the target data unit may be stored as sequence listings for transfer to the synthesis system. In some configurations, the base pair sequences may include the encoded data unit data formatted for each oligo, including address, sync mark, and redundancy data added to the user data for the data unit. The set of oligos may include a plurality of first level codeword sets and their corresponding parity oligos and, in some configurations, nested groups of first level codeword sets, second level codeword sets, and so on for as many levels as the particular recovery configuration supports.

Decoding system 240 may include a processor 242, a memory 244, and a sequencing interface 246. For example, decoding system 240 may be part of a computer or storage system or device configured to receive or access analog and/or digital signal read data from reading sequenced DNA, such as the data signals associated with a set of oligos that have been amplified, sequenced, and read from stored DNA media. Processor 242 may include any type of conventional processor or microprocessor that interprets and executes instructions. In some configurations, processor 242 may include a plurality of processors or processor cores configured to operate alone or in combination to execute one or more functions or sets of instructions described with regard to the other components of decoding system 240. Memory 244 may include a random-access memory (RAM) or another type of dynamic storage device that stores information and instructions for execution by processor 242 and/or a read only memory (ROM) or another type of static storage device that stores static information and instructions for use by processor 242. In some configurations, one or more components of decoding system 240 may be embodied in specialized logic and memory circuits configured for the functions described for decoding system 240 and may incorporate or operate in conjunction with processor 242 and memory 244. For example, one or more decoders, formatters, and/or verification functions may be embodied in a specialized decoder circuit, such as a system on a chip (SOC), field programmable gate array (FPGA), application specific integrated circuit (ASIC), or similar circuit configuration. Decoding system 240 may also include any number of input/output devices and/or interfaces. Input devices may include one or more conventional mechanisms that permit an operator to input information to decoding system 240, such as a keyboard, a mouse, a pen, voice recognition and/or biometric mechanisms, etc. Output devices may include one or more conventional mechanisms that output information to the operator, such as a display, a printer, a speaker, etc. Interfaces may include any transceiver-like mechanism that enables decoding system 240 to communicate with other devices and/or systems. For example, sequencing interface 246 may include a connection to an interface bus (e.g., peripheral component interconnect express (PCIe) bus) or network for receiving analog or digital representations of the DNA sequences from a DNA sequencing system. In some configurations, sequencing interface 246 may include a network connection using internet or similar communication protocols to receive a conventional data file listing the DNA base sequences and/or corresponding digital sample values generated by analog-to-digital sampling from the sequencing read signal of the DNA sequencing system. In some configurations, the DNA base sequence listing may be stored to conventional removable media, such as a universal serial bus (USB) drive or flash memory card, and transferred to decoding system 240 from the DNA sequencing system using the removable media.

In some configurations, a series of processing components 248 may be used to process the read data, such as a read data file or read data signal from a DNA sequencing system, to output a conventional binary data unit, such as a computer file, data block, or data object. For example, processing components 248 may be embodied in decoder software and/or hardware decoder circuits. In some configurations, processing components 248 may be embodied in one or more software modules stored in memory 244 for execution by processor 242. Note that the series of processing components 248 are examples, and different configurations and ordering of components may be possible without materially changing the operation of processing components 248. For example, in an alternate configuration, additional data processing for reversing modulation or other processing from encoding system 210 and/or reassembly of decoded oligo data into larger user data units may be included. Other variations are possible.

Decoding system 240 may use a first stage of error correction targeting the elimination of insertion and deletion errors (which create shifts in all following base pairs in a sequence), followed by ECC error correction to address mutation or erasure errors. DNA media and sequencing face three main types of errors: deletion, insertion, and mutation. Mutation errors are most similar to the traditional errors in data storage and may efficiently be handled using ECC correction. Insertion and deletion errors affect the position of all following bits or symbols and may not be effectively handled by ECC. Therefore, preprocessing the oligo sequences for sequence position shifts and, where possible, correcting those position shifts may contribute to more efficient and reliable data reading. The preprocessing stage may reduce the error rate in the oligo sequences significantly prior to applying ECC correction, enabling more efficient ECC codes and more reliable retrieval of data using a first level of ECC encoding in nested ECC configurations. In some configurations, the preprocessing stage may include reference mark decoder 250, insertion/deletion correction 252, erasure identifier 254, oligo index decoder 256, and oligo set sorter 258.

In some configurations, reference mark decoder 250 may include logic for comparing read data for an oligo to a plurality of different reference matrices to determine the most likely reference pattern for detecting and correcting insertions and deletions based on reference marks with a known frequency. For example, the read data may be processed through multiple attempts to determine a most likely path through correlation matrices corresponding to different possible reference patterns from reference set 238, and resulting scoring from those attempts may be used to select the most likely reference pattern to use for reference mark decoding and timing correction. In some configurations, reference mark decoder 250 may be configured to operate on a single copy of oligo read data and reliably determine the set of reference marks using a correlation matrix to align the possible reference marks and multiple copies of each reference pattern to determine the reference pattern that maximizes the quality of the timing information. As shown in FIG. 3A, a series of operations 302 may generate and populate a correlation matrix based on oligo read data 310. In some configurations, read data 310 may be used to generate a convolutional matrix 320. Convolutional matrix 320 may be based on filtering and stacking reference mark positions 316.1-316.n and user data positions 314.1-314.n from the read data to make alternating columns of the respective base pairs. In the example shown, one base pair of reference marks alternates with one base pair of user data, so filtering may be based on selecting the odd positions as user data values and the even positions as reference mark values. Each column includes a number of base pairs representing the user data portion or the reference mark portion of the oligo (e.g., half the length of the oligo for each type). The center pair of columns 322 comprise the full set of reference mark base pairs and user data base pairs. Each pair of columns in either direction is then offset by one row or base pair of that type (though this represents a two base pair offset when both reference marks and user data are considered). For example, columns 324 are offset by one row from columns 322. Where no read values are available due to the offset of the read data, placeholders 326 may be added. These are null values that are not valid portions of convolutional matrix 320 for subsequent calculations. Similarly, read data values 328 that fall outside of convolutional matrix 320 are not represented in the matrix and are shown merely for illustrating the data shift. The resulting convolutional matrix includes rows corresponding to pairs of positions along the oligo, and the columns correspond to single base pair offsets that, if no insertion or deletion errors were present, would alternate between reference mark base pairs and user data base pairs.

In some configurations, reference set 238 may include a set of unique and predetermined or fixed reference patterns used to encode the reference marks for each oligo. At this point in the processing, which reference pattern was used for the particular oligo may be unknown, and reference mark decoder 250 may sequentially attempt each reference pattern to determine which of the reference patterns was used to encode the reference marks. For example, reference set 238 may include 16 or more different reference patterns. In some configurations, reference set 238 may include reference pattern segments that may be processed in combinations and/or repeated in a plurality of positions to form the larger reference pattern. For example, 256 reference pattern segments may support different positions in the combined reference pattern that encodes an oligo index in addition to providing reference marks for error correction. Reference mark decoder 250 may use a series of reference matrices 330.1-330.n each corresponding to the different reference patterns in reference set 238. Unlike convolutional matrix 320, reference matrices 330 are constructed without offset. Each column 334.1-334.n repeats the reference pattern set of base pairs in reference matrix 330.1-330.n. Each row 336.1-336.n includes the same base pair values corresponding to that position in the reference pattern.

A series of exclusive-or (XOR) operations 340 may then be used to compare each base pair in convolutional matrix 320 with the corresponding matrix position in reference matrices 330.1-330.n. The results of these comparisons may populate a correlation matrix 350 with binary logical matrix values 342. The x-axis 352 denotes the columns of the correlation matrix. The central reference mark column from convolutional matrix 320 corresponds to 0 offset, and each column to the left or right corresponds to a one base pair offset in that direction. In the example shown, a band of 5 offset positions in each direction is being used, with 6 being the nominal (encoded) position of the reference marks, 1 being a 5 base pair shift generally corresponding to the direction of deletions, and 11 being a 5 base pair shift generally corresponding to the direction of insertions. The y-axis 354 denotes the rows of the correlation matrix and corresponds to reference mark positions along the oligo. Medium gray positions, such as block 356, correspond to a 0 value or base pair matches from the XOR comparison. Light gray positions, such as block 358, correspond to a 1 value or base pair mismatches from the XOR comparison. Dark gray positions in the corners of the matrix, such as block 348, correspond to the placeholder or null values that are outside the valid positions of the matrix (created by the data shifts in convolutional matrix 320). Correlation matrix 350 may be used to determine the most likely positions of insertions and deletions based on shifts in the matching values by one or more columns in each direction, as well as determining which of the reference patterns provides the best results and most likely reference pattern to use. Note that while convolutional matrix 320 and reference matrices 330.1-330.n are graphically illustrated with a small number of oligo positions, example correlation matrix 350 is based on a more common oligo size of 150 base pairs, yielding 75 base pair positions corresponding to reference marks at a 0.5 code rate.

As shown in FIG. 3B, a sequence of operations 304 may use a Viterbi-like algorithm 360 to analyze correlation matrix 350 and identify the most likely path through the sequence of reference positions. The algorithm applies one or more traverses of the rows of correlation matrix 350 to determine whether the reference position has shifted due to an insertion or deletion. In some configurations, algorithm 360 is a recursive Viterbi algorithm that uses the probability determined for a prior value in the matrix to determine the probability of the next value in the matrix in the direction of the traversal. Alphaᵢ values 362 may include a set of values corresponding to the next row in correlation matrix 350 to be analyzed. Gammaᵢ values 364 may correspond to a set of values for the column shift or offset of the next row. The offset values may be modified by a probabilistic term based on the log of the exponential function of the prior Alpha values 368 (e^{Alpha}ᵢ₋₁) multiplied by a Toeplitz matrix 366. Toeplitz matrix 366 represents the probabilities of moving from one column to the other (insertions or deletions shifting reference mark alignment) and limits the probable movements to a desired range. An example Toeplitz matrix 370 comprises a central diagonal 372 corresponding to no shift and represented by constant values of 1. The p1 values 374 correspond to a one position shift in either direction. The p1 value may be selected to represent a likelihood of position shift. For example, a p1 value may be 0.03 for one position shift in each direction.

The output of Viterbi algorithm 360 may be a set of probabilities for each row, with the highest probability value indicating the most likely shift or offset for that position (or no shift/offset if the highest probability corresponds to the central reference mark column). In the example shown, indicator (x) 380 in each row corresponds to the column selected for that row as the most likely shift value based on the highest probability value for that row. In some configurations, Viterbi algorithm 360 may be evaluated in multiple directions and summed or averaged to determine the most likely values for each reference position (row). For example, a first direction 382 may correspond to traversing correlation matrix 350 from the top row (first reference mark position in the oligo) to the bottom row (last reference mark position in the oligo). A second direction 384 may correspond to traversing correlation matrix 350 in the reverse or opposite direction from the bottom row (last reference mark position in the oligo) to the top row (first reference mark position in the oligo). The results from the two traversals may then be summed or otherwise evaluated to determine the most likely shift for each reference mark position.

In some configurations, a decoder/compare function 250.1 of reference mark decoder 250 may execute Viterbi algorithm 360 for each reference pattern in reference set 238 and corresponding reference matrices 330.1-330.n and calculate scores for each reference pattern. For example, the sum of columns may provide a relative likelihood value for that reference pattern. These Viterbi scores for each reference pattern may be compared, and the maximum value may indicate the most likely reference pattern. In some configurations, Viterbi scores may be calculated for each reference pattern segment, and corresponding sets of positions in the larger reference pattern and scores compared for each set of positions to determine the most likely reference pattern segment for that position. The resulting most likely reference pattern may be based on the ordered set of reference pattern segments that maximized their respective segment positions. In some configurations, Viterbi normalization may be modified for the comparison of the different reference patterns. For example, the Viterbi scores may not be normalized for each column to improve the comparison of different reference matrices. In some configurations, the Viterbi algorithm 360 may be executed iteratively in response to adjustments made to correct insertions and deletions until reference timing may be restored or the reference timing is determined to be unrecoverable. In some configurations, the Viterbi scores for the different reference patterns may be compared to one another, as well as to a threshold value for acceptable decoding. Based on the most likely reference pattern selected, the output of that correlation matrix and Viterbi analysis may be used for subsequent detection and correction of erasure errors to reestablish the timing of the selected reference pattern.

In some configurations, insertion/deletion correction 252 includes logic for selectively correcting the insertion and deletion errors in an oligo, where possible. For example, insertion/deletion correction 252 may use the output from reference mark decoder 250 to determine correctable insertion/deletion errors. For example, where an insertion or deletion error has occurred between sync marks, the position of subsequent segments may be corrected for the preceding shift in base pair positions to align the symbols in segments without insertions/deletions with their expected positions in the oligo. In some configurations, reference mark decoder 250 may enable insertion/deletion correction 252 to specifically identify likely locations of insertion and/or deletion errors at the base pair level due to the 0.5 code rate.

In some configurations, erasure identifier 254 may flag segments of base pairs in the oligo as erasures in need of ECC error correction. For example, reference mark decoder 250 and related analysis may determine one or more base pairs between sync marks to be identified as erasures for error correction and/or data consensus correction 260. In some configurations, signal quality, statistical uncertainty, and/or specific thresholds for consensus may cause erasure identifier 254 to identify one or more segments as erasures because the processing by reference mark decoder 250 and/or data consensus correction 260 is inconclusive. For example, erasure identifier 254 may be configured to output an oligo that has had as many base pairs or symbols as possible positively identified as not containing insertion or deletion errors and identify (and localize) as erasures any base pairs that cannot be determined to be free of insertion or deletion errors prior to performing ECC error correction. Most commonly, placeholders inserted for identified deletions to restore reference mark timing may be identified as erasures. Note that mutation errors in DNA storage may be equivalent to the erasure errors ECC are configured to correct and need not be identified in the preprocessing stage. In some configurations, the insertion/deletion corrected output oligo base pair sequence and related erasure tags and/or soft information from reference mark decoder 250 may be the output of the preprocessing stage of decoding system 240.

In some configurations, the reference marks may also be configured to encode the oligo index in the reference pattern. For example, the reference marks may include a plurality of reference pattern segments that encode the oligo index value for the oligo index. In these configurations, the most likely reference pattern may be passed to oligo index decoder 256. Oligo index decoder 256 may include logic to determine the oligo index from the reference marks distributed through the oligo read data. For example, the read data for each oligo may include reference marks interspersed with the user data, and the oligo index data may be encoded in one or more sequences of the reference marks. In some configurations, the oligo index may be encoded using correlation to one or more reference patterns in the reference marks. For example, reference set 238 may include reference pattern segments that map to bit values for encoding the oligo address. In some configurations, the oligo address is segmented into multiple oligo address portions that are each encoded using different reference patterns. The series of reference pattern segments from the most likely reference pattern may be used to determine the corresponding oligo address segments. In some configurations, assembly logic 256.1 may identify the series of reference pattern segments and reassemble Those oligo address segments into the oligo address. In some configurations, the oligo address and/or oligo address segments may include redundancy data. Oligo index decoder 256 may perform a redundancy check 256.2 to determine whether the integrity of each oligo address segment and/or the oligo address as a whole is intact. If redundancy check 256.2 fails, operation may return to reference mark decoder, the oligo may be determined to be unreadable, or other error correction processing may be initiated. In some configurations, a CRC check may also be used for oligo index data verification after the oligo index segments are assembled. Oligo index decoder 256 may be configured to only return oligo index data with a high-level of confidence for use in further processing of the oligo read data.

In some configurations, oligo set sorter 258 may include logic to sort a received group of oligo data sequences into sets of copies. For example, the DNA amplification process may result in multiple copies of some or all oligos, and oligo set sorter 258 may sort the oligo data sequences into like sequences. Sorting may be based on tagging during the sequencing process, oligo address data (such as oligo address data from the oligo index decoder 256), and/or statistical analysis of sequences (or samples thereof) to determine repeat copies of each oligo. Note that different copies may include different errors and, at this stage, exact matching of all bases in the sequence may not be the sorting criteria. In this regard, each input oligo may generate a set of one or more oligo copies that correspond to the original input oligo data but may not be identical copies of that data or of one another, depending on when and how the errors were introduced (thus the need for error correction). A set of oligo copies may be processed together, particularly through the first stage of processing, to determine or generate a best copy of the oligo for ECC processing.

In some configurations, data consensus correction 260 may include logic for using comparison of multiple preprocessed copies that have had their reference mark timing recovered to reduce the number of erasure errors and/or resolve inconclusive reference mark corrections. For example, correlation analysis across more than two copies of an oligo may allow statistical methods and soft information values to be compared to a correction threshold for deleting inserted base pairs, inserting padding or placeholder base pairs (which may be identified as erasures by erasure identifier 254), and/or correcting mutation errors that appear in a minority of copies. The correction threshold may depend on the number of copies being cross-correlated, decoder signal-to-noise ratio (SNR), size of the insertion/deletion event, a reliability value of the statistical method, and/or the error correction capabilities of the subsequent ECC processing, including any nested ECC. In some configurations, data consensus correction 260 may be included as part of the preprocessing stage of decoding system 240.

In some configurations, one or more iterative data decoders 262 may be configured to process the output from the preprocessing stage of decoding system 240. For example, a single “best guess” copy of each unique oligo in a set of oligos for a data unit, including erasure flags and/or soft information, may be passed from preprocessing to ECC decoding. In some configurations, reference marks, address fields, and other formatting data may be removed or ignored by decoding system 240 during ECC processing. Decoding system 240 may use one or more levels of ECC decoding based on aggregating the data from a number of oligos (unique oligos rather than copies of the same oligo). For example, decoding system 240 may use LDPC codes constructed for larger codewords than can be written to or read from a single oligo. Therefore, data across multiple oligos may be aggregated to form the desired codewords. Similarly, parity or similar redundancy data may not be retrieved from each oligo and may instead be read from only a portion of the oligos or from separate parity oligos in the oligo set for the target data unit. In some configurations, ECC decoding may then be nested for increasingly aggregated sets of oligos, where each level of the nested ECC corresponds to increasingly larger codewords comprised of more oligos. Decoding system 240 may include one or more oligo aggregators and corresponding iterative decoders. For example, single level ECC encoding may use first level oligo aggregator and first level iterative encoder for codewords of 200-400 oligos. A two-level encoding scheme would use first and second level oligo aggregators and corresponding first and second level iterative encoders, such as for 200 oligo codewords at the first level and 4000 oligo codewords at the second level.

In some configurations, iterative data decoders 262 may help to ensure that the states at the codeword satisfy the parity constraint by conducting parity error checking to determine whether data has been erased or otherwise lost during data read/write processes. It may check the parity bits appended by data encoder 224 during the data encoding process and compare them with the base pairs or symbols in the oligo sequences aggregated by the corresponding oligo aggregators. Based on the configuration of data encoder 224 in the data encoding process, each string of recovered bits may be checked to see if the “1”s total to an even or odd number for the even parity or odd parity, respectively. A parity-based post processor may also be employed to correct a specified number of the most likely error events at the output of the Viterbi-like detectors by exploiting the parity information in the coming sequence. In some configurations, iterative data decoder 262 may use soft information received from preprocessing to assist in decode decision-making. When decode decision parameters are met, the codeword may be decoded into a set of decoded base pair and/or symbol values for output or further processing by symbol decoder 264, RLL decoder 266, Cyclic Redundancy Check (CRC) 268, and/or other data postprocessing.

In some configurations, symbol decoder 264 may be configured to convert the DNA base symbols used to encode the bit data back to their bit data representations. For example, symbol decoder 264 may reverse the symbols generated by symbol encoder 222. In some configurations, symbol decoder 264 may receive the error corrected sequences from iterative data decoders 262 and output a digital bit stream or bit data representation. For example, symbol decoder may receive a corrected DNA sequence listing for one or more codewords corresponding to the originally stored data unit and process the corrected DNA sequence listing through the symbol-to-bit conversion to generate a bit data sequence.

In some configurations, RLL decoder 266 may decode the run length limited codes encoded by RLL encoder 220 during the data encoding process. In some configurations, the data may go through additional post-processing or formatting to place the digital data in a conventional binary data format. For example, CRC 268 may provide a simple and reliable way to check if the decoded codeword is correct or it is a near codeword. CRC 268 may be implemented as a division of the codeword on a primitive polynomial in some Galois field. The CRC value may be determined for each binary data unit and added by the originating system or encoding system 210. For example, the remainder of the division may be stored in the codeword information for the later CRC check after decoding. CRC 268 may be particularly advantageous for DNA storage, where error rate is high and near codeword detection is more probable. After a successful CRC check, the output data 270 may then be output to a conventional binary data storage medium, network, or device, such as a host computer, network node, etc. for storage, display, and/or use as a conventional binary data file or other data unit.

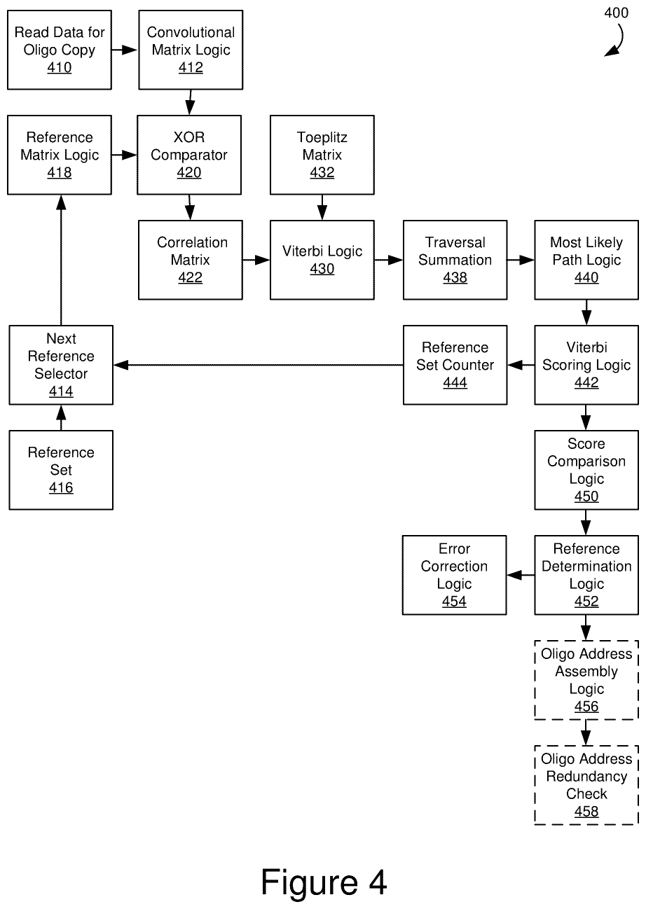

FIG. 4 includes an oligo data processing system 400 using embedded reference marks to determine data offsets from insertions and deletions and, in some configurations, recover the oligo address encoded in the reference marks. In some configurations, blocks 410-454 may include logic and memory configured to execute the functions of reference mark decoder 250 in FIG. 2 and associated operations described with regard to FIGS. 3A and 3B. Block 454 may include logic and memory configured to execute functions of insertion/deletion correction, erasure identifier 254, and/or subsequent error correction by data consensus correction 260, iterative data decoder 262, symbol decoder 264, RLL decoder 266, and/or CRC 268. Blocks 456 and 458 may include logic and memory configured to execute functions of oligo index decoder 256. Blocks 410-458 may be embodied in hardware circuits and/or software modules executed using a processor and memory, such as processor 242 and memory 244 in FIG. 2.

At block 410, read data for an oligo copy may be received in memory. Convolutional matrix logic 412 may generate a convolutional matrix based on separating reference mark positions and user data positions into alternating columns and then offsetting those pairs of columns by one base pair for a sequence of offset positions in both directions. Next reference selector 414 may select a target reference pattern from reference set 416 to use for a first iteration of scoring the most likely path through a corresponding correlation matrix for the convolutional matrix and reference matrix based on the selected reference pattern. Reference matrix logic 418 may access or generate a corresponding reference matrix for the selected matrix pattern, such as by repeating the reference pattern across the columns of the reference matrix. XOR comparator 420 may include logic to execute an XOR comparison of each corresponding value in the convolutional matrix and the two reference matrices to populate a correlation matrix 422. For example, XOR comparator 420 may execute XOR logic between the values from each row of the matrices and return a 0 value for matched base pairs and a 1 value for different base pairs. Example correlation matrix 350 is shown in FIG. 3A, where the light gray areas indicate different base pairs, and the medium gray areas indicate matched base pairs. At this stage, x-indicators 380 for the most likely path may not yet be determined.

Viterbi logic 430 may operate on correlation matrix 422 to determine probability values for each correlation value in the matrix based on traversing the matrix with a Viterbi algorithm. As described above, Viterbi logic 430 may be configured with a Toeplitz matrix 432 to bias the probabilities for single offset changes from the offset position of the prior reference mark position. Viterbi logic 430 may determine a highest probability among the values in each row of correlation matrix 422, as indicated by x-indicators 380 in example correlation matrix 350. In some configurations, Viterbi logic 430 may execute for multiple traverses of correlation matrix 422 and/or portions thereof based on different reference pattern segments encoded in the reference marks. In some configurations, Viterbi logic 430 may be executed through multiple traversals, such as a first (alpha) direction traversal and a second (beta) direction traversal. The resulting probability values for each matrix position may then be summed or otherwise combined by traversal summation 438.

Most likely path logic 440 may use the probability values determined by Viterbi logic 430 directly or through the summation of multiple traversals of correlation matrix 422 to determine the most likely value (and corresponding offset column) for each row in correlation matrix 422. For example, the highest value in each row of example correlation matrices 350 may be annotated with indicator (x) 380 for the highest values, as determined by most likely path logic 440. The results of most likely path logic 440 may be evaluated by Viterbi scoring logic 442 to determine whether the reference mark alignment along the most likely path provides sufficient confidence that the reference mark timing can be accurately recovered. For example, Viterbi scoring logic 442 may sum the probabilities for each column without normalization to determine a confidence score for reference timing based on the selected reference pattern and corresponding reference matrix.

Blocks 414-442 may be executed for each reference pattern in reference set 416 for the convolutional matrix from the read data. In some configurations, reference set counter 444 may be incremented to track progress through the reference set each time a next reference pattern from reference set 416 may be selected by next reference selector 414. Reference set counter 444 may determine when confidence scores have been determined for each reference pattern using Viterbi scoring logic 442, and operation may proceed to score comparison logic 450. Score comparison logic 450 may compare the Viterbi scores for each reference pattern and corresponding reference matrix to determine the most likely reference pattern. For example, the reference pattern with the highest score or score closest to 1 may be selected as the most likely reference pattern. Reference determination logic 452 may receive an indicator of the most likely reference pattern and the corresponding Viterbi score. In some configurations, reference determination logic 452 may also include a confidence threshold for determining whether the most likely reference pattern is sufficiently reliable to use for further error correction and decoding. If that threshold is met, error correction logic 454 may use the column shifts from the most likely path to execute insertion and/or deletion corrections to attempt to restore the original reference mark timing.

In some configurations, reference marks and the reference patterns they include may encode the oligo index or oligo address. Once the most likely reference pattern is determined for the read data by reference determination logic 452, the oligo address may be determined from the reference pattern. Oligo address assembly logic 456 may process the most likely reference pattern to determine the oligo address that it encodes, such as by reference patterns that are uniquely mapped to each oligo address in the oligo pool. In some configurations, this may include dividing the most likely reference pattern into a series of reference pattern segments, where each reference pattern segment maps to an oligo address segment value. The series of oligo address segment values may then be combined to recover the full oligo address. In some configurations, the oligo address may be encoded with one or more sets of redundancy data, and oligo address redundancy check 458 may be used to validate the oligo address or components thereof based on the oligo address data and corresponding redundancy data. Once the oligo address is successfully determined and validated, it may be used to sort copies of the oligo with the same oligo address into sets that can be used for consensus-based error correction and/or reassemble the original data unit by combining the oligo data from the oligos in the oligo pool. Both oligo error correction and reassembly may include additional layers of error correction encoded in the oligo data.

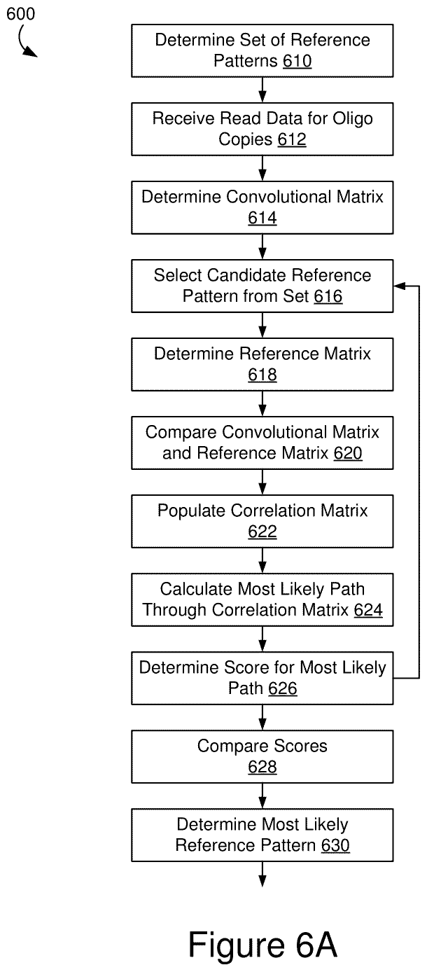

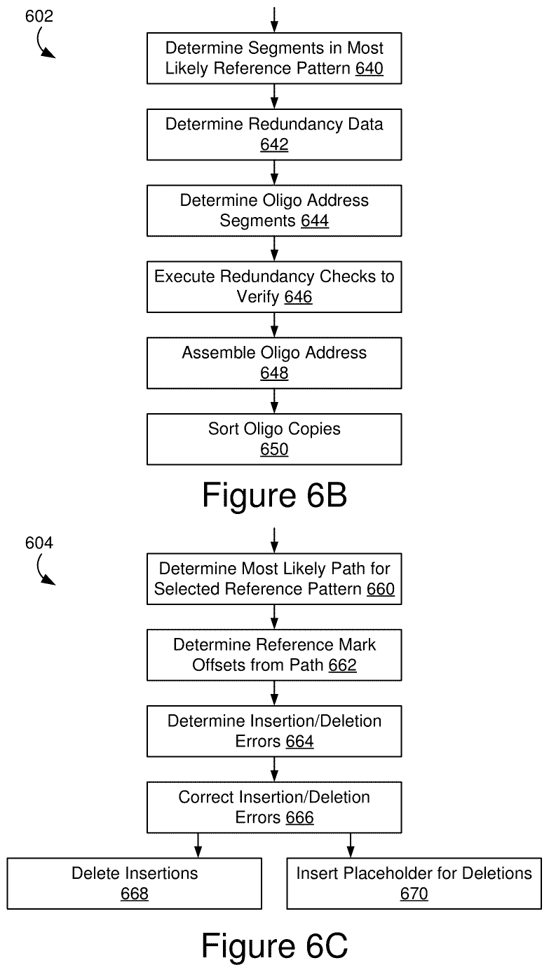

As shown in FIGS. 6A, 6B, and 6C, the decoder in decoding system 240 may be operated according to an example method of recovering reference timing from embedded reference marks in oligo read data and using it for determining oligo address and correcting insertion and deletion errors, i.e., according to the method 600 illustrated by blocks 610-670. In some configurations, sub-method 602 in FIG. 6B may use the most likely reference pattern to determine and use an oligo address encoded in the reference marks. In some configurations, sub-method 604 may use the most likely reference pattern to establish reference mark locations and use them to correct insertion/deletion errors.

At block 610, a set of reference patterns may be determined. For example, the decoder may be configured with a set of reference patterns that include different sequences of reference mark values that correspond to one or more convolutional codes that are easily detected and statistically distinguishable from the oligo data.

At block 612, read data may be received for an oligo. For example, the decoder may receive a sequence of base pairs corresponding to an oligo to be decoded.

At block 614, a convolutional matrix may be determined. For example, the decoder may separate the reference data positions from the user data positions, organize them into paired columns, and then repeat those columns for a desired number of offsets in each direction, such as 5-6 single base pair offsets.

At block 616, a candidate reference pattern from the set of reference patterns may be selected. For example, the decoder may be configured to sequentially process each reference pattern from the set of reference patterns against the read data.

At block 618, a reference matrix may be determined for the selected reference pattern. For example, the decoder may repeat the base pairs from the reference pattern for each column of the reference matrix to match the number of columns in the convolutional matrix.

At block 620, the convolutional matrix may be compared to the reference matrix. For example, the decoder may use an exclusive- or to compare the base pair values in the convolutional matrix with the corresponding matrix position in the selected reference matrix.

At block 622, a correlation matrix may be populated. For example, the decoder may place a corresponding value from the comparisons at block 620 in the corresponding matrix position in a correlation matrix.

At block 624, a most likely path through the correlation matrix may be calculated or otherwise determined. For example, the decoder may apply a Viterbi algorithm to traverse the correlation matrix to determine relative probability values in each row of the correlation matrix for possible shifts in reference mark positions.

At block 626, a confidence score for the most likely path may be determined. For example, the decoder may aggregate probabilities from the correlation matrix to determine a Viterbi score for the selected reference pattern. If there are additional reference patterns to be evaluated, method 600 may return to block 616 to select a next reference pattern to be evaluated for reference mark recovery.

At block 628, the scores for the different reference patterns may be compared. For example, the decoder may compare the confidence scores generated for each reference pattern at block 626 to determine which score is greatest and the most likely or best fit to correspond to the reference pattern used to encode the oligo.

At block 630, a most likely reference pattern may be determined. For example, the decoder may use the comparison at block 628 to determine the best fit reference pattern and corresponding reference marks for further processing. In some configurations, as shown in FIG. 6B, the most likely reference pattern may be used to recover an oligo address encoded in the reference pattern. In some configurations, as shown in FIG. 6C, the most likely reference pattern may be used to establish the reference mark positions and use those positions to correct insertions and deletions prior to further processing the oligo data to decode the corresponding data unit.

At block 640, segments in the most likely reference pattern may be determined. For example, the decoder may be configured to segment the reference pattern into a series of reference pattern segments of a known length.

At block 642, redundancy data may be determined. For example, one or more reference pattern segments may include a combination of oligo address data values and redundancy data for validating the oligo address data, and the decoder may be configured to identify the redundancy data.

At block 644, oligo address segments may be determined. For example, the decoder may include an index, function, or data structure that maps reference pattern values to oligo address data values.

At block 646, redundancy checks may be executed to verify the oligo address and/or oligo address segments. For example, the decoder may use the redundancy data determined at block 642 to validate the oligo address segments determined at block 644.

At block 648, an oligo address may be assembled. For example, the decoder may order the oligo address segments to determine a combined oligo address value.

At block 650, oligo copies in the sequenced data pool may be sorted. For example, replication of the oligos in the data pool may result in multiple copies of each oligo, and the decoder may use the oligo address to group multiple copies together (which may not be identical copies due to replication errors). These sets of oligo copies with the same oligo address may be used for consensus decoding and, ultimately, for reassembling and decoding the corresponding data unit.

At block 660, the most likely path for the reference pattern selected as the most likely reference pattern may be determined. For example, the decoder may use the most likely path through the correlation matrix determined at block 624.

At block 662, reference mark offsets may be determined from the most likely path. For example, the decoder may interpret (relative to the most likely value in the prior row) shifts to the column on the left as one direction of offset and shifts to the column on the right as an opposite direction of offset.

At block 664, insertion and deletion errors may be determined from the offsets. For example, the decoder may evaluate the directions of the offsets as corresponding to sites of insertions or deletions in the oligo copy, such as left offsets corresponding to deletions and right offsets corresponding to insertions.

At block 666, insertion and deletion errors may be corrected in one or more of the oligo copies. For example, the decoder may include logic to insert placeholder values (which may be marked as erasures) for identified deletions at block 670 and delete base pairs identified as insertions at block 668 to compensate for errors and restore the reference mark timing of the user data segments between sequential reference marks.

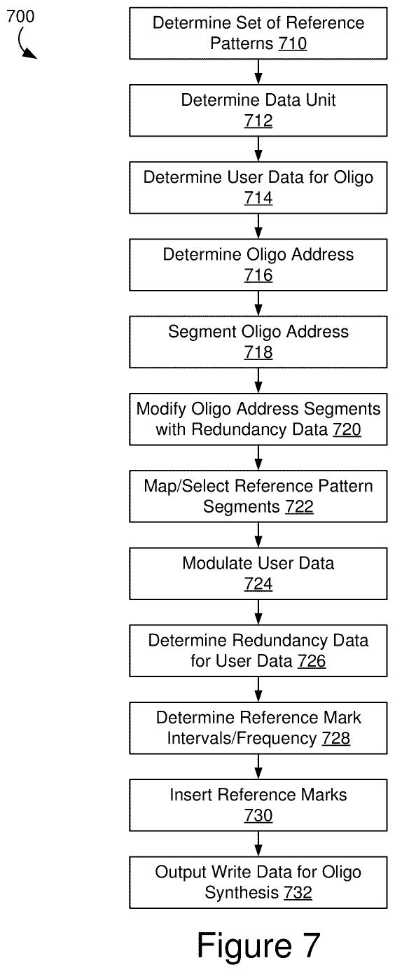

As shown in FIG. 7, the encoder in encoding system 210 may be operated according to an example method of encoding embedded reference marks that include oligo index data in oligos, i.e., according to the method 700 illustrated by blocks 710-732.

At block 710, a set of reference patterns may be determined. For example, the encoder may be configured with a set of reference patterns that include different sequences of reference mark values that correspond to one or more convolutional codes that are easily detected and statistically distinguishable from the oligo data.

At block 712, a data unit may be determined. For example, the encoder may receive a data unit in a conventional binary data format for storage in a set of oligos.

At block 714, user data for the oligo may be determined. For example, an oligo formatter in the encoder may select a portion of user data from the data unit to be written to a target oligo.

At block 716, an oligo address may be determined for encoding the oligo. For example, the oligo formatter may determine an oligo address and/or other syntactic information to be included in the oligo to assist with recovery of the user data and mapping it into a larger user data structure or data unit (e.g., file or data object) that may also include encoding with redundancy data.

At block 718, the oligo address may be segmented. For example, the encoder may segment the oligo address into a series of oligo address segments with shorter bit values.

At block 720, the oligo address segments may be modified with redundancy data. For example, the encoder may calculate redundancy data for each oligo address segment and append the calculated redundancy data to each oligo address segment.

At block 722, reference pattern segments for representing each oligo address segment in a reference pattern may be mapped or selected. For example, the encoder may include an index, data structure, or function for mapping the oligo address segment values to corresponding reference patterns (e.g., distinct convolutional codes) from the set of reference patterns.

At block 724, user data may be modulated. For example, an RLL encoder or similar modulator may use a modulation code selected to assure that the user data does not include the selected reference mark code.

At block 726, redundancy data may be determined for the user data. For example, the user data may be encoded using an error correction code that generates corresponding redundancy data, such as parity data.

At block 728, reference mark intervals or frequency may be determined. For example, the reference mark formatter may be configured for a reference mark interval defining the number of base pairs that should appear between sequential reference marks in the oligo, which may be a single base pair for 0.5 reference mark frequency or code rate.

At block 730, reference marks may be inserted. For example, the reference mark inserter may insert the sequence of reference marks into the user data at the reference mark intervals to define a plurality of user data segments between each pair of sequential reference marks. The reference marks may correspond to the reference patterns selected at block 722 and ordered to form a complete reference pattern for all of the reference marks,

At block 732, write data for the oligo may be output for oligo synthesis. For example, the encoder may generate write data consisting of the user data segments for the target oligo and the reference marks (with embedded oligo index data) and any other added formatting data.

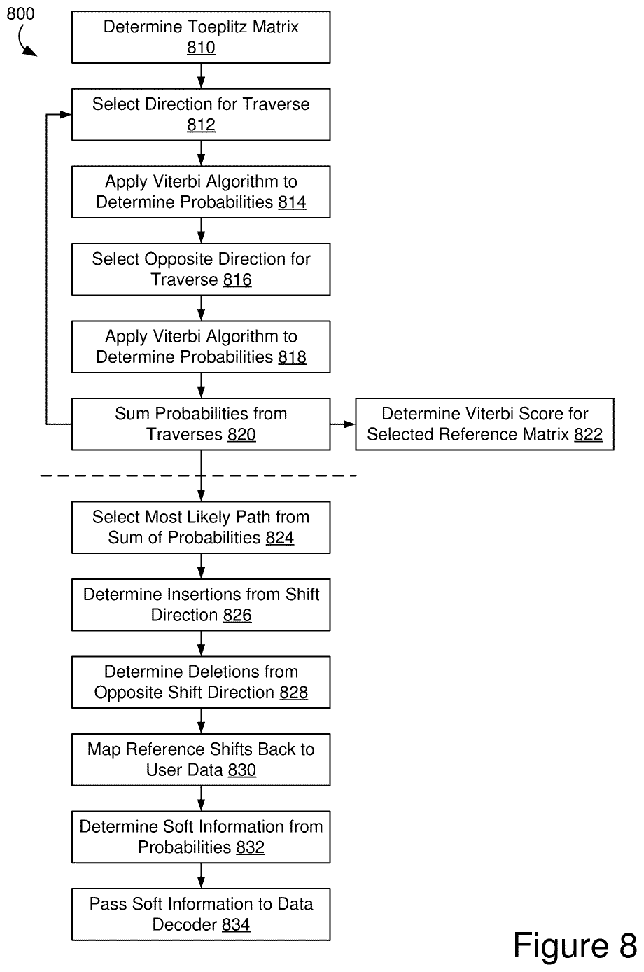

As shown in FIG. 8, the decoder in decoding system 240 and, more specifically, the reference mark decoder 250, may be operated according to an example method of determining probabilities of reference mark shifts using a Viterbi algorithm, i.e., according to the method 800 illustrated by blocks 810-834. In some configurations, the oligo data processing system 400 of FIG. 4 may be embodied at least in part in a reference mark decoder and execute method 800. In some configurations, method 800 may operate in the context of method 600 and, more specifically, provide further detail of the operations for blocks 624-630 on correlation matrices for each reference pattern populated by that method.

At block 810, a Toeplitz matrix may be determined. For example, the decoder may include a Toeplitz matrix configured to modify probabilities for single base pair offsets from a prior reference offset position to determine column changes.

At block 812, a direction may be selected for traverse. For example, the decoder may be configured to traverse the correlation matrix in a first or alpha direction, such as from the top row or start of the read data sequence to the bottom row or end of the read data sequence.

At block 814, the Viterbi algorithm may be applied to determine probabilities for each position in the matrix based on the direction of traversal. For example, the decoder may calculate probabilities for each row through the correlation matrix based on the probability values calculated for the prior row in the correlation matrix based on the direction of the traversal.

At block 816, an opposite direction may be selected for traverse. For example, the decoder may be configured to traverse the correlation matrix in a second or beta direction, such as from the bottom row or end of the read data sequence to the top row or start of the read data sequence.

At block 818, the Viterbi algorithm may be applied to determine probabilities for each position in the matrix based on the direction of traversal. For example, the decoder may make the same calculations as at block 814, but in the opposite direction.

At block 820, probabilities from the traverses may be summed. For example, the decoder may combine the results for each position in the matrix across the two traverses in opposite directions, such as by adding, averaging, or variance calculation. In some configurations, operation may return to block 812 for a next selected reference pattern and corresponding reference matrix,

At block 822, Viterbi scores may be determined for each selected reference matrix. For example, the encoder may calculate a confidence score based on the probability values generated at block 820. These confidence scores may be used by block 628 in method 600 to determine a most likely reference pattern.

At block 824, a most likely path may be selected from the sum of probabilities for the most likely reference pattern. For example, the decoder may evaluate the summed probabilities in each row of the matrix to determine which probability is the highest.

At block 826, insertions may be determined from shifts between adjacent rows in one direction. For example, the decoder may determine that column shifts between one row and the next (corresponding to adjacent reference mark positions) to the right correspond to insertion errors.

At block 828, deletions may be determined from shifts between adjacent rows in the opposite direction. For example, the decoder may determine that column shifts between one row and the next to the left correspond to deletion errors.

At block 830, reference mark shifts may be mapped back to user data. For example, the decoder may use the reference mark position shifts in the context of the full set of oligo positions (reference marks and user data) to locate insertions and deletions in the oligo read data in order to compensate for those shifts and correct reference mark positions/timing.

At block 832, soft information may be determined from the reference mark offset probabilities. For example, the decoder may provide the sets of probabilities mapped to oligo positions and base pair values as a soft information input for subsequent ECC processing of the user data.

At block 834, the soft information may be passed to an iterative data decoder. For example, the decoder may pass the soft information to the iterative ECC decoder for the user data.

Technology for improved encoding and decoding of data for DNA storage is described above. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to particular hardware.

Reference in the specification to “one embodiment” or “an embodiment” means that a particular feature, structure, or characteristic described in connection with the embodiment is included in at least one embodiment or implementation of the disclosed technologies. The appearances of the phrase “in one embodiment” in various places in the specification are not necessarily all referring to the same embodiment or implementation.

Some portions of the detailed descriptions above may be presented in terms of processes and symbolic representations of operations on data bits within a computer memory. A process can generally be considered a self-consistent sequence of operations leading to a result. The operations may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), erasable programmable read-only memories (EPROMs), electrically erasable programmable read-only memories (EEPROMs), magnetic or optical cards, flash memories including USB keys with non-volatile memory or any type of media suitable for storing electronic instructions, each coupled to a computer system bus.

The disclosed technologies can take the form of an entire hardware implementation, an entire software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The terms storage media, storage device, and data blocks are used interchangeably throughout the present disclosure to refer to the physical media upon which the data is stored.

Finally, the processes and displays presented herein may not be inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

1. A system, comprising:
at least one encoder circuit configured to, alone or in combination:
determine an oligo from a set of oligos for encoding a data unit, wherein the oligo encodes a number of symbols corresponding to user data in the data unit;
select a first reference pattern from a plurality of reference patterns configured to be used to encode the set of oligos;
insert a plurality of reference marks at a predetermined interval along a length of the oligo, wherein:
at least a portion of the plurality of reference marks correspond to the first reference pattern; and
the predetermined interval equals a fixed data length between sequential reference marks; and
output write data for the oligo for synthesis of the oligo.

2. The system of claim 1, wherein the predetermined interval of the plurality of reference marks corresponds to a single base pair between sequential reference marks.

3. The system of claim 1, wherein instances of each reference pattern in the plurality of reference patterns are distributed among reference marks inserted into different oligos from the set of oligos.

4. The system of claim 1, wherein a number of different reference patterns in the plurality of reference patterns is at least 16.

5. The system of claim 1, wherein each reference pattern in the plurality of reference patterns encodes at least 8 bits of reference pattern data.

6. The system of claim 1, wherein:
the at least one encoder circuit is further configured to, alone or in combination:
segment the number of symbols into a plurality of oligo data segments; and
select a number of different reference patterns from the plurality of reference patterns equal to a number of the plurality of oligo data segments;
the selected different reference patterns include the first reference pattern; and
the plurality of reference marks corresponds to the selected different reference patterns inserted into corresponding oligo data segments in the plurality of oligo data segments.

7. The system of claim 6, wherein the number of different reference patterns and the number of the plurality of oligo data segments is at least 5.

8. The system of claim 1, wherein:
the at least one encoder circuit is further configured to, alone or in combination:
determine an oligo address for the oligo;
segment the oligo address into a plurality of oligo address segments; and
select different reference patterns from the plurality of reference patterns corresponding to the plurality of oligo address segments;
the plurality of reference marks corresponds to the selected different reference patterns inserted into the oligo;
the oligo address is configured to locate the number of symbols in the data unit relative to other oligos in the set of oligos; and
the selected different reference patterns include the first reference pattern.

9. The system of claim 8, wherein:
the oligo address segments have a first length;
the selected different reference patterns have a second length;
the at least one encoder circuit is further configured to, alone or in combination, modify, prior to selecting the different reference patterns, each oligo address segment of the plurality of oligo address segments with redundancy data for that oligo address segment; and
the redundancy data for each oligo address segment has a length equal to a difference between the first length and the second length.

10. The system of claim 1, further comprising:
at least one decoder circuit configured to, alone or in combination:
receive read data determined from sequencing the oligo;
determine, from the read data, a convolutional matrix for the oligo, wherein each column of the convolutional matrix corresponds to a base pair offset of the read data for the oligo;
select, from a plurality of reference matrices corresponding to the set of reference patterns, a reference matrix for the plurality of reference marks;
determine a correlation matrix based on a comparison of the convolutional matrix to the selected reference matrix;
determine a most likely path through the correlation matrix for the selected reference matrix;
determine a score for the most likely path using the selected reference matrix;
execute selecting the reference matrix, determining the correlation matrix, determining the most likely path, and determining the score for the plurality of reference matrices to generate scores for each reference matrix of the plurality of reference matrices;
determine, by comparing the scores, a best fit reference matrix for the read data; and
decode the oligo based on insertions and deletions indicated by the most likely path for the best fit reference matrix.

11. A method comprising:
receiving read data determined from sequencing an oligo from a set of oligos for encoding a data unit, wherein:
the oligo encodes a number of symbols corresponding to user data in the data unit;
the oligo comprises a plurality of reference marks at a predetermined interval along a length of the oligo;
at least a portion of the plurality of reference marks corresponds to a first reference pattern selected from a plurality of reference patterns configured to be used to encode the set of oligos; and
the predetermined interval equals a fixed data length between sequential reference marks; and
determining, from the read data, a convolutional matrix for the oligo, wherein each column of the convolutional matrix corresponds to a base pair offset of the read data for the oligo;
selecting, from a plurality of reference matrices corresponding to the set of reference patterns, a reference matrix for the plurality of reference marks;
determining a correlation matrix based on a comparison of the convolutional matrix to the selected reference matrix;
determining a most likely path through the correlation matrix for the selected reference matrix; and
decoding the oligo based on insertions and deletions indicated by the most likely path.

12. The method of claim 11, wherein the predetermined interval of the plurality of reference marks corresponds to a single base pair between sequential reference marks.

13. The method of claim 11, wherein instances of each reference pattern in the plurality of reference patterns are distributed among reference marks inserted into different oligos from the set of oligos.

14. The method of claim 11, further comprising:
determining a score for the most likely path using the selected reference matrix;
executing selecting the reference matrix, determining the correlation matrix, determining the most likely path, and determining the score for the plurality of reference matrices to generate scores for each reference matrix of the plurality of reference matrices; and
determining, by comparing the scores, a best fit reference matrix for the read data, wherein decoding the oligo is based on the most likely path for the best fit reference matrix.

15. The method of claim 14, further comprising:
determining, based on the best fit reference matrix, an encoded reference pattern;
segmenting the encoded reference pattern into a plurality of reference pattern segments corresponding to a plurality of oligo address segments; and
determining, based on the plurality of oligo address segments, an oligo address for the oligo, wherein the oligo address is configured to locate the number of symbols in the data unit relative to other oligos in the set of oligos.

16. The method of claim 15, further comprising:
determining, for each reference pattern segment of the plurality of reference pattern segments, redundancy data for that reference pattern segment;
executing, using the redundancy data for each reference pattern segment, a redundancy check for the corresponding oligo address segment in that reference pattern segment to verify integrity of the oligo address; and
assembling the plurality of oligo address segments into the oligo address.

17. The method of claim 11, further comprising, during an encoding operation for the oligo:
determining the oligo from the set of oligos for encoding the data unit;
selecting the first reference pattern from the plurality of reference patterns;
inserting the plurality of reference marks at the predetermined interval along the length of the oligo; and
outputting write data for the oligo for synthesis of the oligo.

18. The method of claim 17, further comprising, during the encoding operation for the oligo:
segmenting the number of symbols into a plurality of oligo data segments; and
selecting a number of different reference patterns from the plurality of reference patterns equal to a number of the plurality of oligo data segments, wherein:
the selected different reference patterns include the first reference pattern; and
the plurality of reference marks corresponds to the selected different reference patterns inserted into corresponding oligo data segments in the plurality of oligo data segments.

19. The method of claim 17, further comprising, during the encoding operation for the oligo:
determining an oligo address for the oligo;
segmenting the oligo address into a plurality of oligo address segments; and
selecting different reference patterns from the plurality of reference patterns corresponding to the plurality of oligo address segments, wherein:
the plurality of reference marks corresponds to the selected different reference patterns inserted into the oligo;
the oligo address is configured to locate the number of symbols in the data unit relative to other oligos in the set of oligos; and
the selected different reference patterns include the first reference pattern.

20. A system comprising:
at least one processor;
at least one memory;
means for receiving read data determined from sequencing an oligo from a set of oligos for encoding a data unit, wherein:
the oligo encodes a number of symbols corresponding to user data in the data unit;
the oligo comprises a plurality of reference marks at a predetermined interval along a length of the oligo;
at least a portion of the plurality of reference marks corresponds to a first reference pattern selected from a plurality of reference patterns configured to be used to encode the set of oligos; and
the predetermined interval equals a fixed data length between sequential reference marks; and
means for determining, from the read data, a convolutional matrix for the oligo, wherein each column of the convolutional matrix corresponds to a base pair offset of the read data for the oligo;
means for selecting, from a plurality of reference matrices corresponding to the set of reference patterns, a reference matrix for the plurality of reference marks;
means for determining a correlation matrix based on a comparison of the convolutional matrix to the selected reference matrix;
means for determining a most likely path through the correlation matrix for the selected reference matrix; and
means for decoding the oligo based on insertions and deletions indicated by the most likely path.
